(19) United States
(12) Patent Application Publication
(10) Pub. No.: US 2015/0339781 A1
(43) Pub. Date: Nov. 26, 2015

(54) Financial Product Risk Mitigation System and Method

(71) Applicant: AMERIPRISE FINANCIAL, INC., Minneapolis, MN (US)

(72) Inventors: Lynn Abbott, Minneapolis, MN (US); Gumer Alvero, Edina, MN (US); Daniel Brooks, Hudson, WI (US); Douglas Dunning, Apple Valley, MN (US); Kerry Kennedy, St Louis Park, MN (US); William Kocken, Coon Rapids, MN (US); Tamara Pollock, Coon Rapids, MN (US); Stephen Wolfrath, Eagan, MN (US)

(73) Assignee: AMERIPRISE FINANCIAL, INC., Minneapolis, MN (US)

(21) Appl. No.: 14/817,542

(22) Filed: Aug. 4, 2015

Related U.S. Application Data
(63) Continuation of application No. 12/329,594, filed on Dec. 7, 2008.
(60) Provisional application No. 61/012,324, filed on Dec. 7, 2007.

(51) Int. Cl. G06Q 40/08; G06Q 40/06

(52) U.S. Cl. CPC G06Q 40/08; G06Q 40/06

(57) ABSTRACT

Automated methods for managing risk associated with investment products is disclosed. A logic engine executes portfolio realignment and contract benefit calculations according to timing rules or event-based triggers. The investment product may provide a guaranteed withdrawal benefit option that allows for a variety of investment, payment, withdrawal, fee and termination options.

### CROSS REFERENCE TO RELATED APPLICATIONS

This application is a continuation of, claims priority to and the benefit of, U.S. Ser. No. 12/329,594 filed Dec. 7, 2008 entitled “Financial Product Risk Mitigation System and Method.” The '594 application claims priority to, and the benefit of, U.S. Provisional Patent Application No. 61/012,324 filed on Dec. 7, 2007, and entitled “Annuity Administration and Risk Mitigation System and Method.” The entire contents of both are hereby incorporated by reference.

### FIELD OF THE INVENTION

The present invention generally relates to administering, managing and mitigating risk in connection with the issuance of an investment product, and more particularly, to automatically reallocating investments and recalculating contract benefits for a guaranteed minimum withdrawal benefit annuity contract.

### BACKGROUND OF THE INVENTION

Investment products are often tailored to address the investment goals of investors. Investment product issuers derive revenue by selling the products to investors and charging fees associated with the products. However, investment products that provide guarantees to an investor regarding the value, benefits or payments of the investment product are also a source of financial risk to the investment product issuers. To manage and mitigate this financial risk, an issuer typically offers the financial product subject to special rules and fees that are incorporated into the financial product through an agreement with the investor. Such agreements can be a legal contract, product terms and conditions, a rider to a contract, a certificate, etc.

For instance, an annuity is a contract in which an investor makes a lump-sum payment or series of payments in exchange for periodic payments which begin either immediately or at some future date. In general, two types of annuities exist—fixed and variable. A fixed annuity is designed to provide that the investor earns on a tax deferred basis a minimum guaranteed rate of interest, plus any discretionary higher rate, during the time that the investor's account is growing. Periodic payments may last for a definite period, such as 20 years, or an indefinite period, such as the lifetime of the investor, or the lifetime of the investor and the spouse of the investor. In contrast, in a variable annuity, an investor may elect to invest in a range of different investment options, typically either in a fixed option (similar to a fixed annuity), or in underlying funds (similar to mutual funds). The rate of return on the variable annuity, and the amount of the periodic payments that will be paid, often varies depending on the performance of the investment options selected.

Traditionally, implementing, maintaining and managing risks for financial products (e.g., annuity contracts, contract riders, certificates, etc.) has been a complex process often rendered inefficient by the need for frequent manual intervention. Furthermore, reducing the risks associated with these financial products is sophisticated and often involves the timely execution of complex rules, reallocation of funds, data intensive or complex calculations of product benefit parameters and fees, etc. Therefore, there is a long felt need for an automated method that reallocates assets and re-establishes benefit parameters of an annuity contract.

### SUMMARY OF THE INVENTION

The present invention improves upon existing systems and methods for administering, managing and mitigating risk associated with financial products. More particularly, the present invention relates to a method and system for administering, managing and mitigating risk for complex annuity contracts and associated contracts such as a rider or a certificate; for example, variable annuity contracts with a guaranteed minimum withdrawal benefit (GMWB) rider.

The invention provides a tangible, integrated, customized and automated management and risk mitigation method that reallocates assets and reestablishes payout parameters during the lifetime of a financial product. For example, when an annuity contract owner requests a withdrawal and a first asset allocation is more aggressive than a target asset allocation model, the system automatically forces a full or partial reallocation of assets into a different, often more conservative, investment model.

For instance, an annuity administration system receives a first asset allocation of annuity funds from the owner. When the owner requests a withdrawal from the annuity funds, the system automatically determines whether the first asset allocation is more aggressive than a target asset allocation that is used as a baseline for mitigating investment risk. If the first asset allocation is more aggressive, then the system automatically reallocates the annuity portfolio into a (e.g., more conservative) second asset allocation model. The owner may still direct the reallocation of funds into a different asset allocation model, but the system limits the owner's options by eliminating one or more of the aggressive investment options. If the owner reallocates the assets into a third asset allocation model that is more aggressive (i.e., riskier) than the second asset allocation model, the system automatically mitigates annuity issuer risk by resetting the annuity benefit parameters.

### BRIEF DESCRIPTION OF THE DRAWINGS

A more complete understanding of the invention may be derived by referring to the detailed description and claims when considered in connection with the Figures, wherein like reference numbers refer to similar elements throughout the Figures, and:

FIG. 1 is an overview of a representative system for automatically administering a variable annuity contract, in accordance with one embodiment of the present invention.

FIG. 2 is a representative high level overview process flow diagram for administering annuity contracts, in accordance with one embodiment of the present invention.

FIG. 3 is a representative process flow diagram for mitigating risk by automatically reallocating annuity investments in response to a withdrawal, in accordance with one embodiment of the present invention.

FIG. 3a is a representative process flow diagram for resetting benefit parameters, in accordance with one embodiment of the present invention.

FIG. 4 is a representative process flow diagram for determining whether to apply an annual step-up in an annuity contract, in accordance with one embodiment of the present invention.

### DETAILED DESCRIPTION OF EXEMPLARY EMBODIMENTS

The detailed description of exemplary embodiments of the invention herein makes reference to the accompanying drawings, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In one embodiment, the system includes a software module, logic engines, computer hardware, numerous databases and computer networks. While the system may contemplate upgrades or reconfigurations of existing processing systems, changes to existing databases and business information system tools are not necessarily required by the present invention. Although certain steps of the invention may be described as automatic, the invention contemplates that any processes or steps may be fully automatic, partially automatic or manual.

The exemplary benefits provided by this invention to financial product issuers include reduced risk, increased processing efficiency, increased operational efficiency and increased ability to provide attractive investment products to customers. Owners (i.e., investors) also benefit by being offered a vast variety of annuity product options with low overhead/administrative costs. Furthermore, in one embodiment the automated asset reallocation feature ensures that the owner, during retirement, has a moderate to low risk factor portfolio to help decrease the volatility of returns. Further, in one embodiment, the guaranteed withdrawals are recalculated with the changed asset allocation model.

While described in the context of systems and methods for improving efficiency and reducing risk for guaranteed minimum withdrawal benefit annuity contracts, practitioners will appreciate that the present invention may be similarly used to reduce risk and administrative costs and provide investors with flexible investment alternatives in a variety of financial products. Moreover, other embodiments of such administration, management and risk mitigation techniques for financial product issuers may be accomplished through a variety of computing resources and hardware infrastructures.

While the description makes reference to specific technologies, system architectures and data management techniques, practitioners will appreciate that this description is but one embodiment and that other devices and/or methods may be implemented without departing from the scope of the invention. Similarly, while the description makes frequent reference to a web client, practitioners will appreciate that other examples of annuity administration tools may be accomplished by using a variety of user interfaces including personal computers, point of service (“POS”) devices, kiosks, handheld devices such as personal digital assistants and cellular telephones.

“Entity” may include any individual, consumer, customer, financial advisor, group, business, organization, government entity, transaction account issuer or processor (e.g., credit, charge, etc.), merchant, consortium of merchants, account holder, charitable organization, software, hardware, and/or any other entity or someone acting on behalf of the entity or user.

“Rider” includes additional features, provisions or information of a financial product (e.g., an annuity rider) including a rider to a contract or a certificate associated with a group contract or revision to an investment plan. Riders often enhance the value of a contract or investment plan; for example an annuity rider increases the value of the annuity while the client is living, enhances the death benefit, or gives other features like extra money if long-term care is needed.

A “financial product administrator” or “financial product issuer” includes any entity that issues, manages, maintains, sells services in connection with, is liable for paying benefits for, or is responsible for administering a financial product.

An “owner” or “client” includes any entity who controls (i.e., has authority to direct) owns or is a current or future beneficiary of a financial product such as an annuity contract or rider.

“Contract date” includes the date from which contract anniversaries, contract years, and contract months are determined.

“Contract anniversary” includes the same day and month as the contract date each year that the contract remains in force.

“Contract year age” includes the age of the contract owner on the contract anniversary.

“Rider effective date” includes the date when the rider becomes effective. In one embodiment, the rider effective date defaults to the contract date unless otherwise provided.

“Rider anniversary” includes the same date as the contract anniversary unless the rider is issued after the contract date. For example, it includes the same day and month as the rider effective date each year that the rider remains in force.

“Waiting period” includes the number of years, starting on the rider effective date, that the ability to utilize both step-ups and withdrawals is specially defined, limited or otherwise altered.

“Withdrawal” includes the amount by which the contract value is reduced as a result of the surrender request. In one embodiment, withdrawal is synonymous with the term “surrender” in the contract.

“Benefit base” includes an amount used to calculate contract benefits and is initially set to the amount of the purchase payment (e.g., premium payment). In one embodiment, the benefit base will be increased by the amount of additional purchase payments. The benefit base can also increase by applying credits, step-ups, spousal continuation step-ups, and certain asset allocation changes associated with contract fund investments (i.e., model portfolio changes). In one embodiment, the benefit can decrease based upon asset allocation changes, excess withdrawals and certain spousal continuations.

“Credit base” includes the amount equal to the sum of the purchase payments and can be reset to zero under various circumstances and is used to determine a credit by multiplying by a credit percentage. In one embodiment, the credit base is set to zero upon first withdrawal, upon applying a final credit, when the contract value goes to zero, or upon election of spousal continuation for a single-life benefit rider.

“Guaranteed benefit amount” (GBA) includes the amount equal to the total cumulative withdrawals guaranteed by a rider. In one embodiment, the GBA cannot be withdrawn and is not payable as a death benefit.

“Remaining benefit amount” (RBA) includes the remaining balance (e.g., on an annuity contract) as the owner makes withdrawals and reduces the amount of GBA that is guaranteed by a rider as future withdrawals. In one embodiment, at any point in time, the RBA equals the amount of GBA that remains.

“Guaranteed benefit payment” (GBP) includes the amount that the rider ensures will be available for withdrawal each contract year, until the earlier of the termination of the rider or the RBA is reduced to zero. In one embodiment, the GBP payment is not paid out until after the waiting period.

“Remaining benefit payment” (RBP) includes the amount that a rider guarantees will be available for withdrawal during the remainder of the current contract year. In one embodiment, as the owner makes withdrawals during a contract year, the remaining amount that the rider guarantees will be available for withdrawal that year is reduced.

“Covered person” includes the person whose life is used to determine when the annual lifetime payment is established and the duration of the annual lifetime payments. In one embodiment, the covered person may change if there is a spousal continuation or a change of ownership. In one embodiment, if the owner is a non-natural person (i.e., a trust, corporation or other entity), the covered person is the oldest annuitant.

“Covered spouses” include the owner and the owner's legally married spouse as defined under federal law, as named on the application and as shown in the contract data for as long as the marriage is valid and in effect. In one embodiment, covered spouses include those identified on the rider effective date and cannot be changed thereafter. In one embodiment, if the owner is a non-natural person (e.g., a trust), the covered spouses include the annuitant and the legally married spouse of the annuitant.

“Annual lifetime payment attained age” (ALPAA) includes the age at which the lifetime benefit is established. In one embodiment, the ALPAA is identified in the contract data. In one embodiment, there may be multiple ALPAAs each associated with an annual lifetime payment percentage.

“Annual lifetime payment” (ALP) includes the amount that a rider guarantees will be available for withdrawal each contract year, until death or termination of the rider, without the possibility of reducing the guarantee provided by the rider. In one embodiment, the ALP is calculated at any time after the rider effective date, or the rider anniversary following the date the covered person reaches the ALPAA if later.

“Remaining annual lifetime payment” (RALP) includes the remaining amount that a rider guarantees will be available for withdrawal that year. In one embodiment, at any point in time after the establishment of the ALP, the RALP equals the amount that the rider guarantees will be available for withdrawal during the remainder of the current contract year.

“Step-up date” includes the date that a step-up is processed for an investment product. Step-ups can be processed in any frequency, e.g., annually, monthly, semi-annually, every “x” years (where x is a numeric integer value). In one embodiment, the step-up date is the rider anniversary date if the annual step-up is processed automatically or, if processed manually, the valuation date received with the owner's written request to step-up. In other embodiments, the step-up date is defined in an alternate form.

For additional definitions and disclosure of additional embodiments, see Riversource® Signature Select Variable Annuity Prospectus, May 1, 2008, and Investment Adviser Disclosure Document (disclosure document provided by RiverSource® Investments, LLC to participants in the Portfolio Navigator Asset Allocation Program), May 1, 2008. Both documents are hereby incorporated as reference. Although these documents may discuss constraints and requirements of various annuity products, benefit parameters and contractual terms, they are incorporated as additional embodiments, and may not be applicable to all embodiments of the present invention, and should not be interpreted to necessarily limit or restrict any of the features or functions set forth herein.

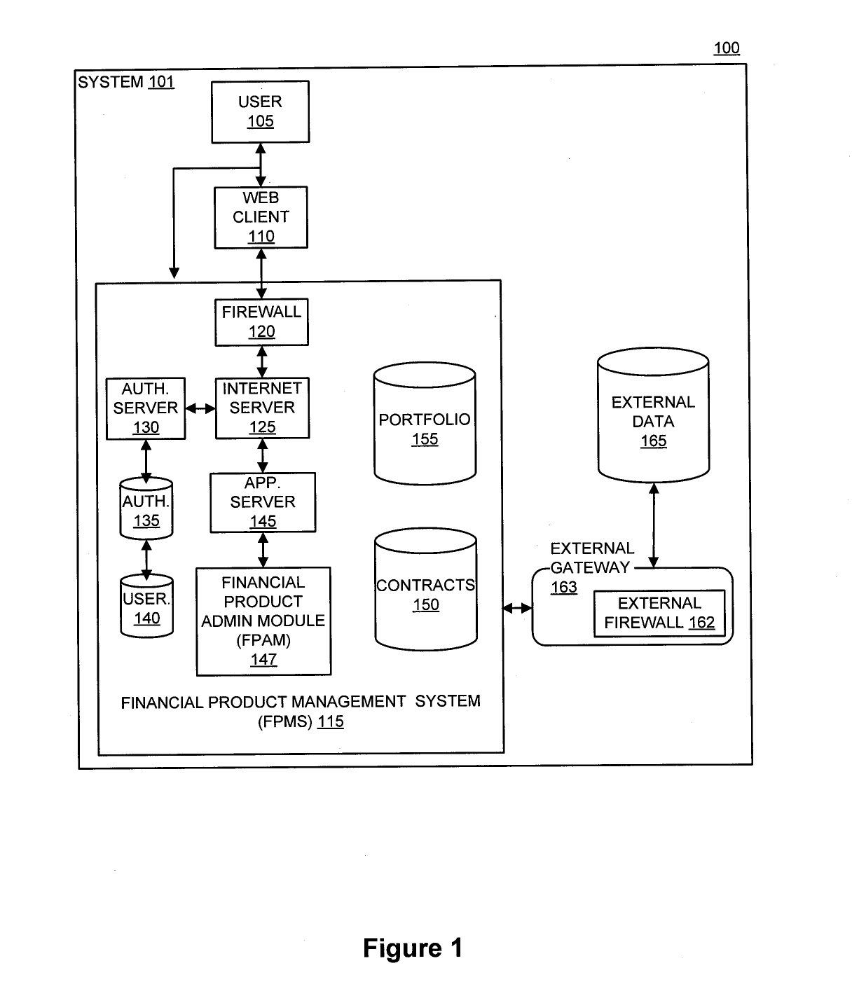

With reference to FIG. 1, in one embodiment, system 101 includes a user 105 interfacing with a financial product administration system (FPMS) 115 by way of a web client 110. User 105 may include any individual or entity that interacts with and/or acts within system 101. User 105 may perform tasks such as requesting, retrieving, receiving, updating, analyzing, entering and/or modifying data. User 105 may be, for example, an annuity administrator accessing FPMS 115 via a web client 110 to manage an annuity contract. User 105 may also be an annuity contract owner accessing the FPMS 115 to, for example, request a withdrawal, print a report, or request a reallocation into a different asset allocation model. User 105 may interface with Internet server 125 via any communication protocol, device or method discussed herein, known in the art, or later developed. In one embodiment, user 105 may interact with FPMS 115 via an Internet browser at a web client 110. In one embodiment, user 105 may be, for example, a customer or a merchant that interacts with FPMS 115 via a web client 110 that is a point of sale device. In one embodiment, user 105 may interact with FPMS 115 via proprietary networks, legacy networks, telecommunication networks or other networks and/or communication links that take advantage of protocols other than the typical Internet protocols.

Web client 110 comprises any hardware and/or software suitably configured to facilitate requesting, retrieving, updating, analyzing, entering and/or modifying data. The data may include verification data, authentication data, authorization data, e-commerce related data or any information discussed herein. Web client 110 includes any device (e.g., personal computer, mobile device), which communicates (in any manner discussed herein) with FPMS 115 via any network discussed herein. Such browser applications comprise Internet browsing software installed within a computing unit or system to conduct online transactions and communications. These computing units or systems may take the form of a computer or set of computers, although other types of computing units or systems may be used, including: laptops, notebooks, hand held computers, mobile phones, mobile devices, POS devices, kiosks, card authorization devices, RFID readers, set-top boxes, workstations, computer-servers, main frame computers, mini-computers, PC servers, pervasive computers, network sets of computers, and/or the like. Practitioners will appreciate that web client 110 may or may not be in direct contact with FPMS 115. For example, web client 110 may access the services of FPMS 115 through another server, which may have a direct or indirect connection to Internet server 125.

The invention contemplates uses in association with annuity administration systems, financial planning systems, financial advice systems, workflow systems, securities trading systems, customer service systems, customer portals, reporting systems, web services, pervasive and individualized solutions, open source, biometrics, mobility and wireless solutions, commodity computing, grid computing and/or mesh computing. For example, in representative embodiments, the present invention may be related to, and incorporate the features of, U.S. Ser. No. 09/712,743, entitled “System and Method For Creating Financial Advice Applications,” and filed Nov. 14, 2000; U.S. Ser. No. 09/731,163, entitled “System and Method For Evaluating Work Product,” and filed Dec. 6, 2000; and U.S. Ser. No. 09/141,013, entitled “Computer-Implemented Program For Planning and Advice System,” and filed Aug. 26, 1998; each of which are hereby incorporated by reference in their entireties.

In another embodiment, web client 110 is configured with a biometric security system that may be used for providing biometrics as a secondary form of identification. The biometric security system may include a transaction device and a reader communicating with the system. The biometric security system also may include a biometric sensor that detects biometric samples and a device for verifying biometric samples. The biometric security system may be configured with one or more biometric scanners, processors and/or systems. A biometric system may include one or more technologies, or any portion thereof, such as, for example, recognition of a biometric. As used herein, a biometric may include a user's voice, fingerprint, facial, ear, signature, vascular patterns, DNA sampling, hand geometry, sound, olfactory, keystroke/typing, iris, retinal or any other biometric relating to recognition based upon any body part, function, system, attribute and/or other characteristic, or any portion thereof.

User 105 may communicate with FPMS 115 through firewall 120 to help ensure the integrity of FPMS 115 components. Internet server 125 may include any hardware and/or software suitably configured to facilitate communications between web client 110 and one or more FPMS 115 components.

Authentication server 130 may include any hardware and/or software suitably configured to receive authentication credentials, encrypt and decrypt credentials, authenticate credentials, and/or grant access rights according to pre-defined privileges attached to the credentials. Authentication server 130 may grant varying degrees of application and data level access to users based on information stored within authentication database 135 and user database 140.

Authentication database 135 may store information used in the authentication process such as, for example, user identifiers, passwords, access privileges, user preferences, user statistics, and the like. User database 140 maintains user information and credentials for FPMS 115 users.

Application server 145 may include any hardware and/or software suitably configured to serve applications and data to a connected web client 110.

Financial product administration module “FPAM” 147 is configured to execute annuity administration tasks. FPAM 147 functions include, for example, automatically recalculating benefit parameters, automatically shifting an annuity into a different asset allocation model, calculating fees, generating reports, enforcing contractual terms, etc. Additionally, FPAM 147 may include any hardware and/or software suitably configured to receive requests from the web client 110 via Internet server 125 and application server 145. FPAM 147 is further configured to process requests, receive responses, execute transactions, construct database queries, and/or execute queries against databases within system 101, external data sources and temporary databases, as well as exchange data with other application modules (not pictured). Moreover, FPAM 147 may reside as a standalone system or may be incorporated with application server 145 or any other FPMS 115 component as program code.

Contract database 150 stores information regarding the annuity contract terms and benefit parameters. Portfolio database 155 stores information regarding the asset allocation models and the specific asset allocations for the annuity contracts. External data 165 includes other sources of data that may be useful in administering annuity contracts and managing investment accounts such as, for example, stock market and other securities data provided by third-parties.

FIG. 1 depicts databases that are included in an exemplary embodiment of the invention. A representative list of various databases used herein includes: user authentication database 135, user database 140, contract database 150, portfolio database 155 and external data 165 and/or other databases that aid in the functioning of the system. As practitioners will appreciate, while depicted as a single entity for the purposes of illustration, databases residing within system 101 may represent multiple hardware, software, databases, data structures and networking components. As practitioners will appreciate, embodiments are not limited to the exemplary databases described above, nor do embodiments necessarily utilize each of the disclosed exemplary databases.

In addition to the components described above, system 101, FPMS 115, and FPAM 147 may further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

As will be appreciated by one of ordinary skill in the art, one or more system 101 components may be embodied as a customization of an existing system, an add-on product, upgraded software, a stand-alone system (e.g., kiosk), a distributed system, a method, a data processing system, a device for data processing, and/or a computer program product. Accordingly, individual system 101 components may take the form of an entirely software embodiment, an entirely hardware embodiment, or an embodiment combining aspects of both software and hardware. Furthermore, individual system 101 components may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

Web client 110 may include an operating system (e.g., Window XP, Windows NT, 95/98/2000, XP, Vista, OS2, UNIX, Linux, Solaris, MacOS, Windows Mobile OS, Windows CE, Palm OS, Symbian OS, Blackberry OS, J2ME, etc.) as well as various conventional support software and drivers typically associated with mobile devices, computers or other user interfaces. Web client 110 can be in a home or business environment with access to a network including both wireless and wired network connections. In an exemplary embodiment, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp. Web client 110 may be independently, separately or collectively suitably coupled to the network via data links which include, for example, a connection to an Internet Service Provider (ISP) over the local loop as is typically used in connection with standard wireless communications networks and/or methods, modem communication, cable modem, Dish networks, ISDN, Digital Subscriber Line (DSL), see, e.g., Gilbert Held, Understanding Data Communications (1996), which is hereby incorporated by reference.

Firewall 120 may comprise any hardware and/or software suitably configured to protect the FPMS 115 components from users of other networks. Firewall 120 may reside in varying configurations including stateful inspection, proxy based and packet filtering, among others. Firewall 120 may be integrated as software within Internet server 125, any other system components, or may reside within another computing device or may take the form of a standalone hardware component.

Internet server 125 may be configured to transmit data to the web client 110 within markup language documents. As used herein, “data” may include encompassing information such as commands, queries, files, data for storage, and/or the like in digital or any other form. Internet server 125 may operate as a single entity in a single geographic location or as separate computing components located together or in separate geographic locations. Further, Internet server 125 may provide a suitable web site or other Internet-based graphical user interface, which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, InterBase, etc., may be used to provide an Active Data Object (ADO) compliant database management system.

Similar to Internet server 125, the application server 145 may communicate with any number of other servers, databases and/or components through any means known in the art. Further, the application server 145 may serve as a conduit between the web client 110 and the various systems and components of the FPMS 115. Internet server 125 may interface with the application server 145 through any means known in the art including a LAN/WAN, for example. Application server 145 may further invoke software modules such as the FPAM 147 in response to user 105 requests.

Any of the communications, inputs, storage, databases or displays discussed herein may be facilitated through a web site having web pages. The term “web page” is not meant to limit the type of documents and applications that may be used to interact with the user. For example, a typical web site may include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and/or the like. A server may include a web service that receives a request from a web server, the request including a URL (http://yahoo.com/stockquotes/ge) and an internet protocol (“IP”) address. The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., Alex Nghiem, IT Web Services: A Roadmap for the Enterprise (2003), hereby incorporated by reference.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In an embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the system by multiple and unrelated owners of the data sets. For example, a first data set which may be stored may be provided by a first party, a second data set which may be stored may be provided by an unrelated second party, and yet a third data set which may be stored, may be provided by a third party unrelated to the first and second parties. Each of the three data sets in this example may contain different information that is stored using different data storage formats and/or techniques. Further, each data set may contain subsets of data that also may be distinct from other subsets.

As stated above, in various embodiments of system 101, the data can be stored without regard to a common format. However, in one embodiment of the invention, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier, TXA-ID or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer, may be received by a stand-alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand-alone device, the appropriate option for the action to be taken. System 101 contemplates a data storage arrangement wherein the header or trailer, or header or trailer history, of the data is stored on the transaction instrument in relation to the appropriate data.

One skilled in the art will also appreciate that, for security reasons, any databases, systems, devices, servers or other components of system 101 may consist of any combination thereof at a single location or at multiple locations, wherein each database or system includes any of various suitable security features, such as firewalls, access codes, encryption, decryption, compression, decompression, and/or the like.

System 101 may be interconnected to external data 165, (for example, to obtain data from a vendor) via a second network, referred to as the external gateway 163. The external gateway 163 may include any hardware and/or software suitably configured to facilitate communications and/or process transactions between systems. Although depicted in FIG. 1 as facilitation communication between external data 165 and FPMS 115, one skilled in the art will appreciate that external gateway 163 may be suitably configured to facilitate communications and/or process transactions between any two systems or sub-systems including system 101, FPMS 115 and the external data 165. Interconnection gateways are commercially available and known in the art. External gateway 163 may be implemented through commercially available hardware and/or software, through custom hardware and/or software components, or through a combination thereof. External gateway 163 may reside in a variety of configurations and may exist as a standalone system or may be a software component residing, for example, inside FPMS 115 or any other known configuration. External gateway 163 may be configured to deliver data directly to system 101 components and to interact with other systems and components such as external data 165 databases. In one embodiment, external gateway 163 may comprise web services that are invoked to exchange data between the various disclosed systems. External gateway 163 represents existing proprietary networks that presently accommodate data exchange for data such as financial transactions, customer demographics, billing transactions and the like. External gateway 163 is a closed network that is assumed to be secure from eavesdroppers.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice,” by William Stallings, published by Prentice Hall; all of which are hereby incorporated by reference.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Practitioners will appreciate that there are a number of methods for displaying data within a browser-based document. Data may be represented as standard text or within a fixed list, scrollable list, drop-down list, editable text field, fixed text field, pop-up window, and/or the like. Likewise, there are a number of methods available for modifying data in a web page such as, for example, free text entry using a keyboard, selection of menu items, check boxes, option boxes, and/or the like.

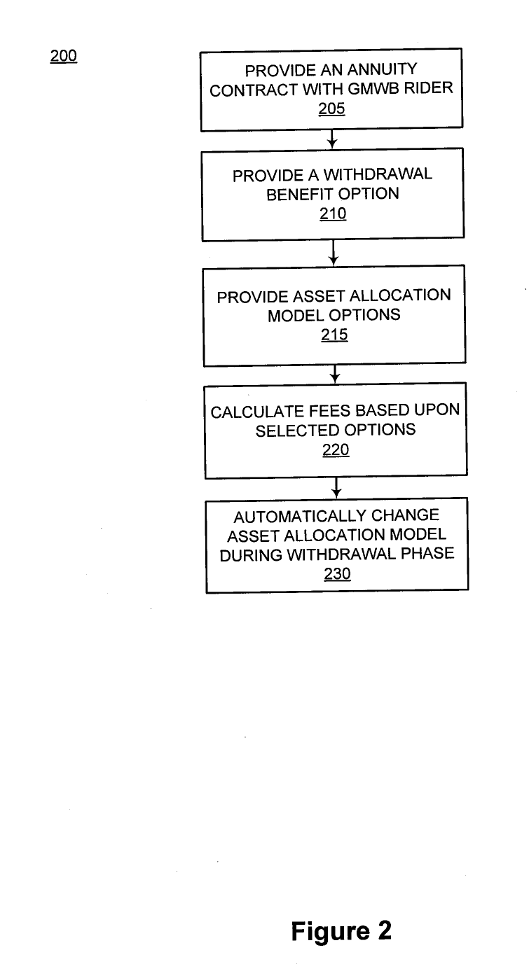

The block system diagrams and process flow diagrams represent mere embodiments of the invention and are not intended to limit the scope of the invention as described herein. For example, the steps recited in FIG. 2 may be executed in any order and are not limited to the order presented. It will be appreciated that the following description makes appropriate references not only to the steps depicted in FIG. 2, but also to the various system components as described above with reference to FIG. 1.

With reference to FIG. 1, in one embodiment, when user 105 logs on to an application, Internet server 125 may invoke an application server 145. Application server 145 invokes logic in FPAM 147 by passing parameters relating to user's 105 requests for data. FPMS 115 manages requests for data from FPAM 147 and communicates with system 101 components such as, for example, contracts database 140. Transmissions between user 105 and Internet server 125 may pass through a firewall 120 to help ensure the integrity of FPMS 115 components. Practitioners will appreciate that the invention may incorporate any number of security schemes or none at all. In one embodiment, Internet server 125 receives data or page requests from web client 110 and interacts with various other system 101 components to perform tasks related to requests from web client 110.

Internet server 125 may invoke an authentication server 130 to verify the identity of user 105 and assign specific access rights to user 105. In order to control access to application server 145 or any other component of FPMS 115, Internet server 125 may invoke authentication server 130 in response to user 105 submissions of authentication credentials received at Internet server 125. When a request to access system 101 is received from Internet server 125, Internet server 125 determines if authentication is required and transmits a prompt to web client 110. User 105 enters authentication data at web client 110, which transmits the authentication data to Internet server 125. Internet server 125 passes the authentication data to authentication server which queries user database 140 for corresponding credentials. When user 105 is authenticated, user 105 may access various applications and their corresponding data sources.

One embodiment of the present invention provides owners with an optional GMWB rider that can be coupled with a variable annuity contract. Though many of the embodiments are described in terms of a GMWB rider, the invention is not limited to managing and mitigating risk for GMWB riders. The invention is not limited to riders for variable annuity contracts and is implemented in various embodiments for fixed annuity and other non-variable annuity financial products. In various embodiments, the invention enables an investment product issuer to implement, administer, manage and mitigate risk for a variety of investment products. For example, in one embodiment, the invention is used to implement riders for automated partial withdrawal programs, and in an embodiment, the invention enables risk management for an investment product associated with a certificate which defines additional terms and benefits associated with a group contract. In one embodiment, rider benefits are adjusted to account for external conditions. For example, the effect of inflation is offset by annually adjusting benefits by either a fixed percentage or a percentage determined by an index (e.g., the consumer price index (CPI)).

The GMWB rider can be configured in a variety of ways. In one embodiment, an annuity rider is intended to provide guaranteed withdrawals up to a pre-determined withdrawal amount each year from an annuity contract. In one embodiment, guaranteed withdrawals can occur regardless of investment performance of the annuity contract. This allows the owner to withdraw, at a minimum, the purchase payments made to the annuity contract plus the purchase payment credits. In one embodiment, the annuity contract provides the right to withdraw limited amounts in each contract year.

In one embodiment, if the owner does not take a withdrawal in a contract year, or does not take a withdrawal in a number of successive contract years (e.g., no withdrawal for three years), then a credit is applied whereby the benefit base is increased by a certain percentage of, for example, premiums or credit base. Credits are amounts that can be added to the benefit base. In one embodiment, the credit base is used only to determine rider credits and not to determine amounts available for withdrawal or annuitization. In one embodiment, the credit amount is limited by including only purchase payments in the credit base. In other words, the issuer limits the credit by not including step-up amounts or the effect of previous credits in the credit base (e.g., the credit calculation does not have a compounding effect). In one embodiment, the credit is a one-time credit available only once during the lifetime of the contract. In addition to the timing and number of credits available, in one embodiment, the amount of the credit (as determined by a percentage) also varies.

In one embodiment, a credit is added to the benefit base of a rider on the rider anniversary date through the 10th rider anniversary date, subject to certain limitations described below. On the first rider anniversary date, the rider credit equals the credit base 180 days following the rider effective date, multiplied by 6%. On subsequent applicable rider anniversary dates, the rider credit equals the credit base as of the prior rider anniversary date, multiplied by 6%. The credit base is determined as follows, subject to a maximum amount of $10,000,000: On the contract date, the credit base (like the benefit base) is set equal to the initial purchase payment. The credit base is increased by the amount of each additional purchase payment if the credit base is greater than zero. The credit base is permanently set to zero if: the contract value falls to zero; a withdrawal is made; the covered person changes after spousal continuation (in the case of a single-life rider); or, the 10th rider anniversary date has passed.

In addition to increasing the guaranteed benefit amount (i.e., increasing the base for determining future payments), rider rules are also structured that allow the lifetime withdrawal percent (i.e., the percentage that is applied to the base in a payment calculation) to vary. In one embodiment, if the owner does not take a withdrawal in a contract year, or does not take a withdrawal in a number of successive contract years (e.g., no withdrawal for three years), then the lifetime withdrawal percentage increases. For example, the payment percentage increases 0.25 percent per year for three successive contract years. In one embodiment, the credit and/or payment percentage increase is available multiple times or is available multiple times up to a maximum number of times, up to a maximum payment percentage and/or other suitable threshold. Moreover, in an embodiment, the payment percentage varies according to the age of the investment product owner.

The options for setting up the GMWB rider may allow the owner to choose either a single life-GMWB rider or a joint life-GMWB rider. In one embodiment, the owner is eligible for an enhanced benefit depending on certain events, e.g., increasing the benefit if the owner is admitted to a nursing home or managed care facility. Fees associated with riders are also structured in a variety of ways. For example, the fees may vary by the risk associated with the asset allocation model chosen for the annuity investments.

The rider provides for a variety of withdrawal options. In one embodiment, the rider provides two types of guaranteed minimum withdrawal options: a principal-back option or a lifetime-benefit option. The principal-back option is executed according to a variety of rules. In one embodiment, the principal-back option provides the owner, for a pre-defined time period, with a pre-defined withdrawal percentage of the purchase payments and/or purchase payment credits per month, until the cumulative purchase payments are exhausted. The lifetime-benefit option is executed according to a variety of rules. In one embodiment, the lifetime-benefit option provides the owner with a pre-defined withdrawal percentage of the purchase payments and/or purchase payment credits at a pre-defined frequency (e.g., every month or every year), for the entire duration of the annuity contract.

In one embodiment, the single life rider covers one person. The terms of the rider may specify the maximum age the covered person can be when the rider is issued or becomes effective. For example, a rider may specify that the person should be of age 80 or younger at the time the contract is issued. In one embodiment, the single life rider includes a provision for providing the same rider to surviving spouses or successive owners with recalculated benefits. The single life rider may guarantee that regardless of the investment performance, the annuity contract allows the covered person to withdraw up to a certain amount each year from the contract before the annuity payouts begin (e.g., by annuitizing the base contract) until the owner has recovered, at minimum, the purchase payments plus any purchase payment credit or, if later, a different amount will be payable until death if the contract value is zero.

In one embodiment, a principal-back option guarantees the covered person and/or his heirs are guaranteed to get their principal back over time, as long as withdrawals are not more than the ALP each year. In one embodiment, the principal-back guarantee is equal to total purchase payments reduced by the amount of withdrawals. Upon death of the covered person, the beneficiary's options include (1) receiving the death benefit available under the contract, (2) continuing the contract under spousal continuation (if available) or (3) taking the principal-back guarantee under the rider. If the principal-back guarantee is chosen, the beneficiary receives a stream of payments until total payments to the beneficiary are equal to the principal-back guarantee at the time of death.

In one embodiment, the joint-life rider jointly covers one person with his/her spouse and requires the spouse to be named at the time the contract is issued. The terms of the rider may specify the maximum age the covered persons can be when the rider is issued or becomes effective. For example, a rider specifies that the covered person and spouse should be of age 80 or younger at the time the contract is issued. In one embodiment, the joint life rider is passed on to a successive spouse. When structured according to this embodiment, the joint life rider guarantees that regardless of the investment performance, the annuity contract allows the covered person to withdraw up to a certain amount each year from the contract before the annuity payouts begin until the owner has recovered at minimum all of the purchase payments plus any purchase payment credit or, if later, until the death of the last surviving covered spouse even if the contract value is zero. Fees associated with the GMWB riders are different for single life-GMWB riders (“single life rider”) and joint life-GMWB riders (“joint life rider”).

In one embodiment of the joint-life rider, the death benefit becomes payable at the death of a covered spouse and the surviving covered spouse must utilize the spousal continuation provision to continue the joint benefit. If the spousal continuation is unavailable under the contract terms, the rider terminates. Spousal continuation provisions can be structured in various ways. Spousal continuation may be subject to multiple provisions including, for example: (1) the rider continues as part of the contract; (2) The waiting period is cancelled and any waiting period limitations on withdrawals and step-ups terminate; and (3) The surviving covered spouse can name a new beneficiary, however, a new covered spouse cannot be added to the rider. In one embodiment, at the time of spousal continuation, a step-up may be available.

In one embodiment, if the contract value is greater than zero when the death benefit becomes available, the beneficiary may: (1) elect to take the death benefit under the terms of the contract, (2) take the fixed payout option under the rider, or (3) if the beneficiary is the spouse, continue the contract under the spousal continuation feature of the contract.

FIG. 2 shows a representative method for administering an annuity rider with risk mitigating features. An annuity administrator provides an annuity contract with an optional GMWB rider (Step 205). In one embodiment, the GMWB is part of the original annuity contract. The annuity administrator provides the owner with features such as a withdrawal benefit option (Step 210) and a pre-defined asset allocation model (Step 215). One embodiment includes a guaranteed minimum withdrawal option where the owner has a principal-back option and a lifetime-benefit option. The principal-back option permits the owner to withdraw a pre-defined amount at a pre-defined frequency (e.g., every month), for a pre-defined time period. For example, if the annuity contract has an investment of $100,000, then the owner can withdraw 7% of $100,000 per year, for approximately 14 years. Furthermore, in an exemplary embodiment, the lifetime-benefit option permits the owner to withdraw a pre-defined withdrawal percentage, for the duration of the annuity contract. For example, if the annuity contract has an investment of $100,000, then the owner is guaranteed 6% of $100,000 per year, for the lifetime of the annuity contract.

The investments made into an investment product such as an annuity contract may be invested in a variety of ways. In one embodiment, deposits are made into sub-accounts with underlying portfolios by the investment product administrator. For example, the underlying portfolios may be comprised of stocks, bonds and/or money market instruments. Automated tools are often used to assist in identifying asset allocation models and investments to accomplish certain investment objectives. Such automated tools may include probability modeling, stochastic modeling, simulation, portfolio integration and portfolio reconciliation functions. A portfolio integration module facilitates integration of at least one of a user's goals, assets, savings, and risk tolerance in analyzing and developing a customized strategy for financial planning of the user. A portfolio reconciler module communicates with the portfolio integration module to facilitate comparison of the customized strategy to other strategies and projected financial decisions in order to further facilitate the financial planning of the user. A stochastic modeling module in communication with the portfolio integration module and the portfolio reconciler module uses data from the portfolio integration module and/or the portfolio reconciler module in a stochastic modeling analysis to facilitate creation of a proposed situation portfolio for the user. The stochastic modeling module uses a synchronous stationary bootstrap method of statistical sampling to facilitate analysis of historical economic data in order to facilitate creation of the proposed situation portfolio.

A simulator module in communication with the portfolio integration module and the stochastic modeling module may be used to forecast the effects of changes to the probability modeling system and to monitor and test the system over a predetermined amount of time. For more detail regarding these tools, their functions, and other features and functions that may be incorporated into certain embodiments of the present invention see, for example, U.S. patent application Ser. No. 10/210,827 filed on Jul. 31, 2002, entitled “System And Method For Providing Financial Planning And Advice”; U.S. patent application Ser. No. 10/837,849 Filed On May 3, 2004, entitled “Portfolio Integration Module For Providing Financial Planning And Advice”; and U.S. patent application Ser. No. 10/838,114 Filed On May 3, 2004, entitled “Portfolio Reconciler Module For Providing Financial Planning And Advice”; each of which are hereby incorporated by reference.

The value of an investment product (e.g., cash value associated with the annuity contract) fluctuates based upon the investment performance of the portfolios. As one of ordinary skill will appreciate, assets in an investment product may be adjusted over time. Moreover, the adjustment of assets may be triggered by a large variety of events and the reallocation may follow various strategies to accomplish a multitude of asset allocation, risk mitigation, cost reduction or other objectives.

Referring again to FIG. 2, the annuity provider provides the owner with a range of pre-defined and/or custom tailored asset allocation models (Step 215). For example, the pre-defined asset allocation models are a conservative model, a moderately conservative model, a moderate model, a moderately aggressive model and an aggressive model. For instance, in the aggressive model, the investments of the owner are invested in high risk factor portfolio that has the potential for higher rate of investment returns, while in the conservative model, the investments are invested in a lower risk factor portfolio that has a relatively lower rate of investment returns. Based on the specific owner requirement for retirement, the owner selects one of the pre-defined asset allocation models and/or specifies a custom model. The annuity provider then implements the selected asset allocation model in the annuity contract.

The annuity provider calculates the fees associated with the selected GMWB rider and the features (Step 220). The fees associated with the single life rider and the joint life rider are often different. For example, the fees for the single life rider are 0.65% of the greater of the RBA or the contract anniversary value. In one embodiment, during the withdrawal phase, the annuity provider removes the aggressive asset allocation options from the pre-defined asset allocation models and automatically changes the selected pre-defined asset allocation model to a less aggressive option (Step 230). For example, during the withdrawal phase, the moderately aggressive model selected by an owner may be reallocated to the moderate model, and the moderately aggressive model and the aggressive model withdrawn from the pre-defined asset allocation models. In one embodiment, the moderately aggressive model and the aggressive model are not withdrawn from the pre-defined asset allocation models but if the owner elects an aggressive model after the withdrawal, rider benefits are adjusted.

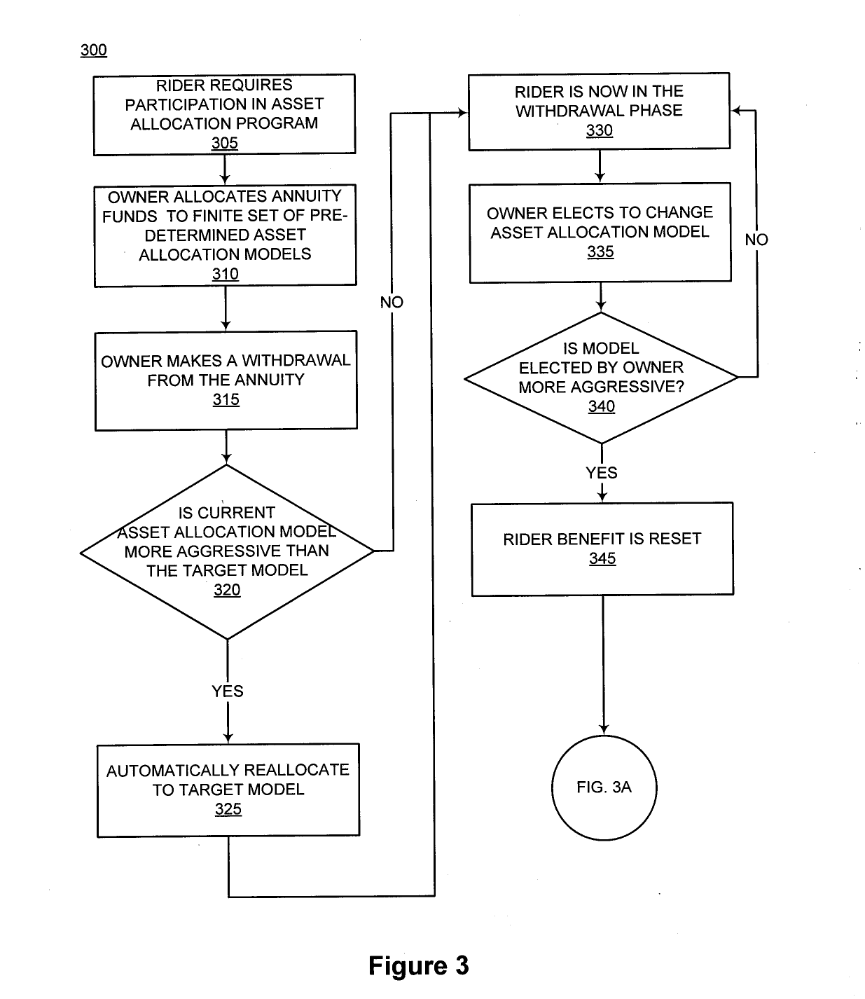

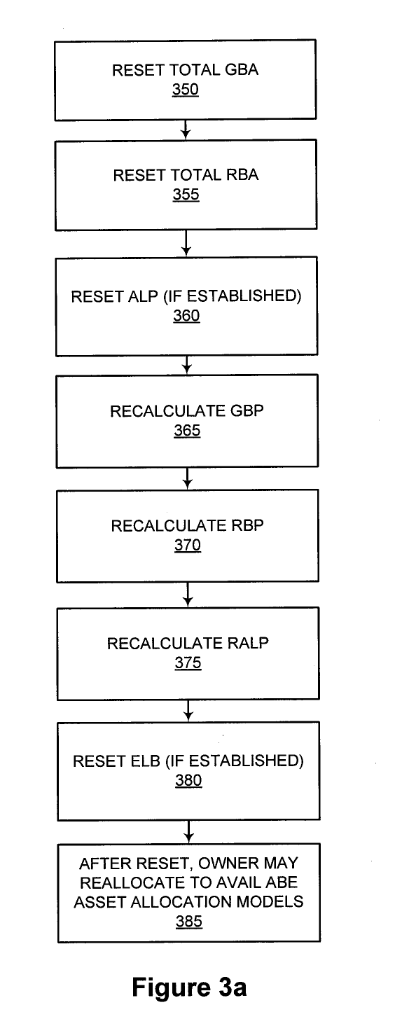

As illustrated in FIG. 3, in one embodiment, the rider requires the owner to select one of the pre-defined asset allocation models during the tenure of the annuity contract (Steps 305-310). In one embodiment, the pre-defined set of asset allocation models available is determined as a function of the amount of the initial purchase payment for the contract. In one embodiment, rider benefits vary depending upon the asset allocation chosen. For instance, the rider may allow for a higher credit or higher lifetime payment if a less aggressive model is chosen. Prior to any withdrawals, the owner may elect to reallocate the annuity to any available asset allocation model. The owner allocates the contract value to any available asset allocation model based upon any timing schedule. For instance, the timing schedule may dictate asset allocation: (1) prior to the first withdrawal; and/or (2) following a benefit reset as described below but prior to any subsequent withdrawal.

At the time of withdrawals (Step 315), FPAM 147 compares the current asset allocation with a target asset allocation model (Step 320). If the current asset allocation model is more aggressive than the target model, FPAM 147 automatically moves the annuity into a less aggressive asset allocation model (Step 325). After a withdrawal, the annuity is in the withdrawal phase (Step 330). In one embodiment, during the withdrawal phase, the aggressive asset allocation models are removed from the pre-defined asset allocation models. In one embodiment, the aggressive asset allocation models are not withdrawn from the pre-defined asset allocation models but if the owner elects an aggressive asset allocation model after the withdrawal, rider benefits are adjusted. This exemplary strategy provides the owner with more varied investment options during the accumulation phase as compared to the withdrawal phase. While in the withdrawal phase, the owner is permitted to reallocate the annuity into any available asset allocation model that is the same or more conservative than the target model without triggering a reset of the benefit parameters. However, if the owner elects to reallocate the annuity (Step 335) into an asset allocation model that is more aggressive than the target model (Step 340), the benefit parameters are reset (Step 345). As illustrated in FIG. 3a, in one embodiment, the benefit parameters that are reset include: the total GBA (Step 350), the total RBA (Step 355), the ALP (if it is has been established) (Step 360), the GBP (Step 365), the RBP (Step 370), the RALP (Step 375) and the enhanced lifetime base (ELB) (if it has been established) (Step 380).

The rider benefits are reset in a variety of ways depending on the event that triggers the reset. In one embodiment, if the owner is in the withdrawal phase and chooses to allocate the contract value to a model portfolio that is more aggressive than the target model portfolio, the rider benefit is reset according to the following rules:

(a) The total GBA is reset to the lesser of its current value or the contract value;

(b) The total RBA is reset to the lesser of its current value or the contract value;

(c) The ALP, if established, is reset to the lesser of its current value or 6% of the contract value;

(d) The GBP is recalculated as the sum, for each purchase payment, of the lesser of (i) the individual GBA multiplied by the GBP percentage specified in the contract, and (ii) the individual RBA;

(e) The RBP is recalculated as the reset GBP less all prior withdrawals made during the current contract year, but not less than zero; and

(f) The RALP is recalculated as the reset ALP less all prior withdrawals made during the current contract year, but not less than zero.

As one skilled in the art will appreciate, fees may be calculated in a variety of ways and deducted in a variety of methods.

In one embodiment, the owner is charged different fee levels for riders based on the owner's chosen asset allocation. The rider fee may be deducted once a year from the contract value on the contract anniversary. In one embodiment, the fee is pro-rated among the variable sub-accounts, and the regular fixed account (if applicable) in the same proportion the value in each account bears to the total contract value less amounts in guarantee period accounts or any special account (e.g., a dollar cost average, “DCA”). In one embodiment, such charges are only deducted from guarantee period accounts and any account (e.g., a DCA) if insufficient amounts are available from the fixed account and variable sub-accounts. The fee may be calculated on the contract anniversary. In one embodiment, the fee is calculated by multiplying the annual rider charge by the greater of the anniversary contract value or the total RBA. This charge may vary with the asset allocation model. Rules governing changes in the fee are structured in a multitude of ways. For instance, the charge increases if:

(A) The owner elects to change the asset allocation model and the annual rider charge for the new asset allocation model is higher; or

(B) The owner elects the annual step-up or spousal continuation step-up. The new charge is the charge in effect on the valuation date received with a written request to change the asset allocation model or step-up. There is no increase in the annual rider charge for automatic annual step-ups, automatic spousal continuation step-ups, or for any required reallocation of the owner's contract value to the target model following a withdrawal. The annual rider charge is subject to the maximum annual rider charge shown under contract data. If the rider charge changes during a contract year, an average rider charge is calculated, for that contract year only, that reflects the various different charges that were in effect that year, adjusted for the number of calendar days each charge was in effect.

In various embodiments, fees associated with step-ups are based upon an opt-in or an opt-out rule. Under the opt-in rule, if there is not a fee change, the annual step-up is automatic and when there is a fee change, the client “opts-in” to the step-up feature by, for example, submitting a written request for step-up and accepting the higher fee. Under the opt-out rule, annual step-ups are automatic and if there is a fee change the client accepts the fee change by default or “opts-out”, for example, by submitting a written request declining the step-up and associated fee increase.

Furthermore, a variety of rules are structured to handle termination of an annuity contract. For instance, if the annuity contract or rider is terminated for any reason, the rider charge is deducted and adjusted for the number of calendar days coverage was in place during the contract year. Also, there are a variety of rules associated with change of ownership of an annuity contract. In one embodiment, benefits are reset if the contract is assigned or ownership is transferred to another person and in another example, the contract administrator retains the right to review and/or approve a rider assignment, or cancel the rider.

Terms dictating the timing and amount of withdrawals are structured in many different ways. For instance, the amount that is withdrawn in each contract year varies depending on several factors, including waiting period and whether or not the lifetime withdrawal benefit has become effective:

(1) The basic withdrawal benefit gives the owner the right to take limited withdrawals in each contract year and guarantees that over time the withdrawals totals an amount equal to, at minimum, the purchase payments plus any purchase payment credits, unless the rider is terminated.

(2) The lifetime withdrawal benefit gives the owner the right, under certain limited circumstances defined in the rider, to take limited withdrawals until the later of, for example:

Death, rider termination, or until the RBA (under the basic withdrawal benefit) is reduced to zero for a single life rider.

Death of the last surviving covered spouse or until the RBA (under the basic withdrawal benefit) is reduced to zero (unless the rider is terminated) for a joint life rider.

Continuing the discussion of the various options for structuring the permissive timing of withdrawals, in one embodiment, only the basic withdrawal benefit is in effect prior to the date that the lifetime withdrawal benefit becomes effective. For example, the lifetime withdrawal benefit becomes effective automatically on the rider anniversary date after the:

(1) Covered person reaches age 65, or the rider effective date if the covered person is age 65 or older on the rider effective date for a single life rider;

(2) Younger covered spouse reaches age 65, or the rider effective date if the younger covered spouse is age 65 or older on the rider effective date for a joint life rider.

In one embodiment, rider benefits are calculated based upon the age of the owner while in another embodiment, rider benefits are calculated based upon the owner's contract year age and benefits may change based upon when the owner's real age changes (e.g., on the owner's birthday) or when the contract year age changes.

In one embodiment, as long as annuity payouts have not begun a rider guarantees that the owner is permitted to take the following withdrawal amounts each contract year:

(1) Before the establishment of the ALP, the rider guarantees that each year the owner has the option to cumulatively withdraw an amount equal to the value of the RBP at the beginning of the contract year;

(2) After the establishment of the ALP, the rider guarantees that each year the owner has the option to cumulatively withdraw an amount equal to the value of the RALP or the RBP at the beginning of the contract year, but the rider does not guarantee withdrawal of the sum of both the RALP and the RBP in a contract year. If the owner withdraws less than the allowed withdrawal amount in a contract year, the unused portion cannot be carried over to the next contract year. As long as the withdrawals in each contract year do not exceed the allowed annual withdrawal amount under the rider and there has not been a benefit reset as a result of certain model changes, for example: (1) for a single life rider there has not been a contract ownership change or spousal continuation of the contract, the guaranteed amounts available for withdrawal do not decrease; (2) for a joint life rider the guaranteed amounts available for withdrawal do not decrease.

Excess withdrawals are another component of a rider. Excess withdrawals trigger an adjustment of a benefit's guaranteed amount, which may cause it to be reduced. For instance, if the owner withdraws more than the allowed annual withdrawal amount in a contract year, this is called an “excess withdrawal” under the rider. An adjustment of a benefit's amount due to excess withdrawal may be a pro-rata reduction or a full reset. In one embodiment, a pro rata reduction reduces benefit guarantees based on the proportion of the withdrawal that is in excess of the allowable withdrawal amount compared to the contract value and a full reset resets benefit guarantees to the lesser of the current guarantees and the remaining contract value after the withdrawal.

Basic withdrawal benefit and lifetime withdrawal benefit each has its own definition of the allowed annual withdrawal amount and these benefits may be structured in a variety of different ways. For example, a withdrawal is considered an excess withdrawal for purposes of the lifetime withdrawal benefit only, the basic withdrawal benefit only, or both. Furthermore, some embodiments may include the rule that if the withdrawals exceed the greater of the RBP or the RALP, surrender charges under the terms of the contract apply. In one embodiment, the amount deducted from the contract value is the amount requested plus any applicable surrender charge. Market value adjustments are another optional feature which is present in some embodiments. Also, in some embodiments, withdrawals taken under the contract reduce the value of the death benefits. Finally, in some embodiments, upon full surrender of the contract, the owner receives the remaining contract value less any applicable charges.

In one embodiment, a rider's guaranteed amounts are increased at any specified interval if the contract value has increased. For example, an annual step-up feature (discussed below) is available at each contract anniversary, subject to certain conditions, and is applied automatically to the rider values or may require the owner to elect the step-up. In one embodiment, if the owner exercises the annual step-up election, the spousal continuation step-up election or changes the portfolio navigator model portfolio, the rider charge changes.

In one embodiment, if the owner takes withdrawals during the waiting period, any prior steps-ups applied are reversed and step-ups are not available until the end of the waiting period. The owner may take withdrawals after the waiting period without reversal of prior step-ups.

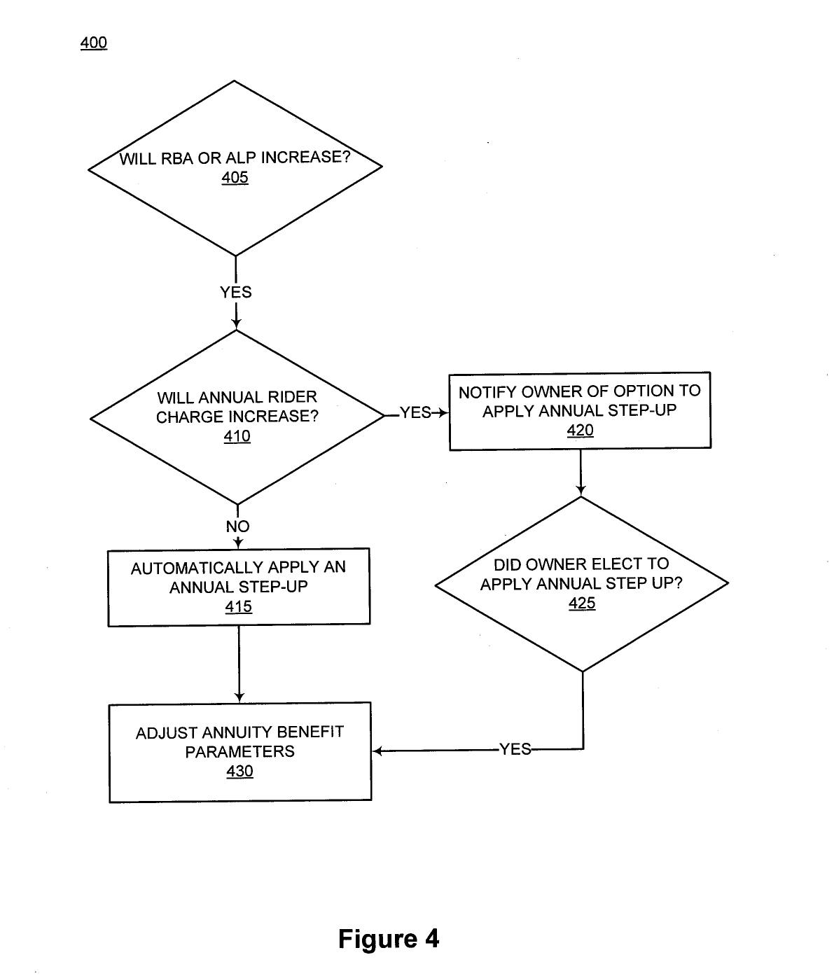

Terms dictating the timing and amount of step-ups are structured in many different ways. For instance, beginning with the first rider anniversary, a step-up is available. Step-ups may be processed (e.g., determined and applied) based upon any time frequency specified in the contract (e.g., quarterly, annually, etc.) In one embodiment, if the owner takes any withdrawals during the waiting period, any previously applied annual step-ups are reversed and the annual step-up is made unavailable until the rider anniversary following the waiting period. In one embodiment, the annual step-up is effective on the step-up date. In one embodiment only one annual step-up is allowed each contract year. An example of how the annual step-up is available is illustrated in FIG. 4 described below.

Referring now to FIG. 4, a representative process for administering step-ups in an annuity contract or rider is shown. On any rider anniversary where the RBA, or if established the ALP, would increase and the annual rider charge would not increase as a result of the annual step-up (Steps 405-410), the annuity administrator executes the annual step-up automatically on the step-up date (Step 415). In one embodiment, during the waiting period, step-ups are not available if a withdrawal is taken. In one embodiment, the end of the waiting period is the day prior to the anniversary. If the annual step-up results in an increase of the annual rider charge, the annuity administrator does not execute the annual step-up automatically and the owner is notified (Step 420). The owner then has the option to elect the annual step-up, with the resulting charge increase, anytime within the 30 days following that rider anniversary as long as the contract value is greater than the total RBA or the contract value multiplied by the ALP percentage shown under contract data is greater than the ALP, if established, on the step-up date (Step 425). If the annual step-up is executed, the annuity benefit parameters, including the total RBA, total GBA, GBP, RBP, ALP, and RALP, are adjusted (Step 430).

A variety of rules are structured to dictate the terms by which a rider is terminated.

For example in one embodiment, the GMWB rider cannot be terminated either by the owner or the annuity administrator except as follows:

(1) For a single life rider, after the death benefit is payable the rider terminates if:

(a) any one other than the spouse continues the contract, or

(b) the spouse does not use the spousal continuation provision of the contract to continue the contract.

(2) For a joint life rider, after the death benefit is payable the rider terminates if:

(a) any one other than a covered spouse continues the contract, or

(b) a covered spouse does not use the spousal continuation provision of the contract to continue the contract.

(3) Annuity payouts under an annuity payout plan terminate the rider.

(4) Termination of the contract for any reason terminates the rider.

While a financial vehicle is discussed above, the invention contemplates that such financial vehicle may be registered for, specified, implemented, automated and/or administered via any automated means discussed herein or hereinafter developed. While the steps outlined above represent a specific embodiment of the invention, practitioners will appreciate that there are any number of computing algorithms and user interfaces that may be applied to create similar results. The steps are presented for the sake of explanation only and are not intended to limit the scope of the invention in any way.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims of the invention. It should be understood that the detailed description and specific examples, indicating exemplary embodiments of the invention, are given for purposes of illustration only and not as limitations. Many changes and modifications within the scope of the instant invention may be made without departing from the spirit thereof, and the invention includes all such modifications. Corresponding structures, materials, acts, and equivalents of all elements in the claims below are intended to include any structure, material, or acts for performing the functions in combination with other claim elements as specifically claimed. The scope of the invention should be determined by the appended claims and their legal equivalents, rather than by the examples given above. Reference to an element in the singular is not intended to mean “one and only one” unless explicitly so stated, but rather “one or more.” Moreover, when a phrase similar to “at least one of A, B, or C” is used in the claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

1. (canceled)

2. A computer-implemented method comprising:
selecting, by a computer-based system configured for managing financial risks within financial products, an asset allocation model for a financial product, from a pre-determined set of asset allocation models,
where the financial product has a benefit parameter,
where the pre-determined set of asset allocation models include at least one of increased financial risk, moderate financial risk, less financial risk or lowest financial risk,
where the asset allocation model is defined based on at least one of an amount of an initial purchase payment for the financial product, a withdrawal being taken, a cumulative withdrawal amount, the contract year or the age of the contract owner,
updating, by the computer-based system, the pre-determined set of asset allocation models, based on the performance of the financial product;
updating, by the computer-based system, the pre-determined set of asset allocation models, based on a change to a profile of the contract owner;
actuating, by the computer-based system, a periodic withdrawal from the financial product,
where the periodic withdrawal is part of the guaranteed minimum withdrawal benefit (GMWB) rider;
comparing, by the computer-based system, the asset allocation model of the financial product to a target asset allocation model,
where the asset allocation model is more financial risk than the target asset allocation model,
resetting, by the computer-based system, a benefit parameter in response to a contract owner selecting the asset allocation model from the pre-determined set of the asset allocation models to create a selected asset allocation model,
where the selected asset allocation model has more financial risk than the target asset allocation model,
executing, by the computer-based system and on another financial system, a reallocation of at least a portion of assets of the financial product based the target asset allocation model.

3. The method of claim 2, where the financial product is at least one of: a rider to a contract, a contract for a financial product or a certificate associated with a group contract associated with a financial product.

4. The method of claim 3, where the benefit parameter comprises at least one of: guaranteed benefit amount (GBA), remaining benefit amount (RBA), guaranteed benefit payment (GBP), remaining benefit payment (RBP), annual life-time payment (ALP), remaining annual lifetime payment (RALP), enhanced lifetime benefit (ELB), guaranteed minimum withdrawal benefit (GMWB) rider, principal-back, benefit base or credit base.

5. The method of claim 4, where the pre-determined set of asset allocation models comprises increased financial risk with 70% to 100% equity, moderate financial risk with 55% to 80% equity, moderate financial risk with 40% to 65% equity, less financial risk with 25% to 45% equity or lowest financial risk with 0% to 30% equity.

6. The method of claim 5, where the selected asset allocation model does not include the asset allocation models that are more financial risk than the target asset allocation model.

7. The method of claim 6, where the periodic withdrawal includes a predefined withdrawal percentage in the range 3.5% to 7.0% and the pre-defined withdrawal percentage varies according to at least one of the age of the contract owner, the age of a contract owner spouse, the age of an annuitant, the age of an annuitant spouse, or an active asset allocation model.

8. The method of claim 7, where the periodic withdrawal includes a predefined withdrawal percentage of 5% when the contract owner is 60 years of age and the predefined withdrawal percentage of 6% when the contract owner is 65 years of age.

9. The method of claim 8, further comprising resetting benefit parameters responsive to at least one of: receiving an instruction to allocate a second asset allocation or at least one of receiving an instruction to process a withdrawal, receiving an instruction to process an ownership change, receiving an instruction for spousal continuation, or receiving an instruction to process an annual step-up.

10. The method of claim 9, where the resetting the benefit parameter comprises:
setting a total guaranteed benefit amount (GBA) equal to the lesser of (i) its current value and (ii) the contract value;
setting a total remaining benefit amount (RBA) equal to the lesser of (i) its current value and (ii) the contract value;
in response to an annual lifetime payment (ALP) already being established, setting the ALP to the lesser of (i) an ALP current value, and (ii) an ALP percentage associated with the contract multiplied by at least one of the contract value or a benefit base associated with the financial product;
setting a total guaranteed benefit payment (GBP) equal to the sum, for each purchase payment, of the lesser of (i) the individual GBA multiplied by a GBP percentage associated with the contract, and (ii) the individual RBA;
setting a remaining benefit payment (RBP) equal to the greater of (i) the GBP minus all withdrawals made during the current contract year and (ii) zero;
setting a remaining annual lifetime payment (RALP) equal to the greater of (i) the ALP minus all withdrawals made during the current contract year and (ii) zero; and
in response to an enhanced lifetime base (ELB) being already established, setting the ELB to the lesser of (i) an ELB current value and (ii) the contract value.

11. The method of claim 10, where the benefit parameter is adjusted at a pre-determined frequency by a percentage determined by at least one of an inflation index, or an adjusted inflation index, where the adjusted inflation index is determined by the inflation index and an active asset allocation.

12. A financial products management system (FPMS) comprising:
a processor configured for managing financial risks within financial products,
a tangible, non-transitory memory configured to communicate with the processor,
the tangible, non-transitory memory having instructions stored thereon that, in response to execution by the processor, cause the processor to perform operations comprising:
selecting, by the processor, an asset allocation model for a financial product, from a pre-determined set of asset allocation models,
where the financial product has a benefit parameter,
where the pre-determined set of asset allocation models include at least one of increased financial risk, moderate financial risk, less financial risk or lowest financial risk,
where the asset allocation model is defined based on at least one of an amount of an initial purchase payment for the financial product, a withdrawal being taken, a cumulative withdrawal amount, the contract year or the age of the contract owner,
updating, by the processor, the pre-determined set of asset allocation models, based on the performance of the financial product;
updating, by the processor, the pre-determined set of asset allocation models, based on a change to a profile of the contract owner;
actuating, by the processor, a periodic withdrawal from the financial product,
where the periodic withdrawal is part of the guaranteed minimum withdrawal benefit (GMWB) rider;
comparing, by the processor, the asset allocation model of the financial product to a target asset allocation model,
where the asset allocation model is more financial risk than the target asset allocation model,
resetting, by the processor, a benefit parameter in response to a contract owner selecting the asset allocation model from the pre-determined set of the asset allocation models to create a selected asset allocation model,
where the selected asset allocation model has more financial risk than the target asset allocation model,
executing, by the processor and on another financial system, a reallocation of at least a portion of assets of the financial product based the target asset allocation model.

13. An article of manufacture including a non-transitory, tangible computer readable storage medium having instructions stored thereon that, in response to execution by a computer-based system configured for managing financial risks within financial products, cause the computer-based system to perform operations comprising:
selecting, by the computer-based system, an asset allocation model for a financial product, from a pre-determined set of asset allocation models,
where the financial product has a benefit parameter,
where the pre-determined set of asset allocation models include at least one of increased financial risk, moderate financial risk, less financial risk or lowest financial risk,
where the asset allocation model is defined based on at least one of an amount of an initial purchase payment for the financial product, a withdrawal being taken, a cumulative withdrawal amount, the contract year or the age of the contract owner,
updating, by the computer-based system, the pre-determined set of asset allocation models, based on the performance of the financial product;
updating, by the computer-based system, the pre-determined set of asset allocation models, based on a change to a profile of the contract owner;
actuating, by the computer-based system, a periodic withdrawal from the financial product,
where the periodic withdrawal is part of the guaranteed minimum withdrawal benefit (GMWB) rider;
comparing, by the computer-based system, the asset allocation model of the financial product to a target asset allocation model,
where the asset allocation model is more financial risk than the target asset allocation model,
resetting, by the computer-based system, a benefit parameter in response to a contract owner selecting the asset allocation model from the pre-determined set of the asset allocation models to create a selected asset allocation model,
where the selected asset allocation model has more financial risk than the target asset allocation model,
executing, by the computer-based system and on another financial system, a reallocation of at least a portion of assets of the financial product based the target asset allocation model.
